(19) United States
(12) Patent Application Publication
(10) Pub. No.: US 2006/0068157 A1
(43) Pub. Date: Mar. 30, 2006

(54) Artificial ski slope surface

(75) Inventor: John Nike, Bracknell (GB)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Nike Land Securities LTD., Bracknell (GB)

(21) Appl. No.: 10/533,673

(22) PCT Filed: Oct. 22, 2003
(86) PCT No.: PCT/GB03/04560

§ 371 Date: May 3, 2005

(30) Foreign Application Priority Data
Nov. 6, 2002 (GB) 0225822.6

(51) Int. Cl. D05C 17/00; B32B 3/06; B32B 33/00

(52) U.S. Cl. 428/95; 428/88; 428/89; 428/99; 428/100

(57) ABSTRACT

There is described a two-part artificial ski slope surface comprising a looped filament carpet and a resilient base layer and in addition a looped filament carpet which may be attached to a base layer. The looped filament carpet provides a continuous carpet pile, which may have a random directional weave and loops of different heights to provide different surface characteristics in addition, the material used for the looped filament carpet may also be selected to provide different surface characteristics. The characteristics of the surface are selected to provide surface having different degrees of difficulty and for allowing for different frictional contact between the surface and the user, thereby controlling the speed of the user over the surface.

### TECHNICAL FIELD

The invention relates to an artificial ski slope surface, a looped filament carpet for use in such a surface and a method of constructing such a surface.

### BACKGROUND OF THE INVENTION

Artificial ski slopes are used throughout Great Britain, Europe and other parts of the world. Artificial ski slopes provide an environment in which, for example, novice and experienced skiers, snowboarders and tobogganers are able to participate in so-called “winter sports” all year round and, in particular, where snow falls are scarce or insufficient to allow for these activities on a natural surface. Artificial ski slopes are also useful for training or teaching purposes year round.

Conventional artificial ski slope surfaces take a number of forms. One example is a surface comprising PVC bristles which are held in steel channels. The channels are then tied together at intervals to form a mesh like mat.

Other surfaces include injection moulded bristles fabricated into units or a carpet type material, both of which are generally fabricated of plastics.

In bristle mats the surface provides the low friction requirement by having large spaces between areas of bristles, for example the bristles may be arranged in a diamond configuration on the surface. These spaces have been found to result in injuries, in particular to hands and thumbs. When a user falls their hands, or another part of their body, may become caught in one of the spaces thereby causing injury. Furthermore, injuries may be sustained since matting of this form provides very little shock absorption, meaning that impact injuries are common. Other injuries include grazing or abrasion when the skin slides over the ends of the bristles, which may be further exacerbated if the bristles are broken and the broken ends are sharp, and injuries caused by contact with the metal channels or the metal ties holding the channels together.

Even when in an unworn state conventional artificial ski surfaces may fail to provide a surface which is sufficiently low friction to be able to satisfactorily simulate skiing on real snow.

In addition, debris or grit may accumulate in the bristles and this will increase the friction between the surface and the skis. Additionally, since the bristles are generally densely packed they will tend to, at their point of contact with the ski, cause abrasion and wear to the underside of the ski.

In order to provide an enhanced surface it is known to use sprinkler systems to “water” the surface to keep the bristles wet. However, this still does not provide an ideal artificial ski slope surface. In addition, the installation, maintenance and continuous use of sprinkler systems is expensive.

Further differences between artificial ski slope surfaces and snow include that snow retains a visible track after a skier has passed over it. Such a track may be useful for training purposes and is not produced using conventional artificial ski slope surfaces.

It is therefore desired to provide a sufficiently low friction artificial ski slope surface which reduces the risk of injury whilst providing properties similar to that of snow. It is further desired that the artificial ski surface reduces the requirement for a sprinkler system and is quick and easy to replace where necessary without compromising safety.

### SUMMARY OF INVENTION

According to the present invention there is provided an artificial ski slope surface for laying on an underlying surface, the artificial surface comprising a looped filament carpet and a resilient base layer, said carpet being releasably attached to said base layer. Examples of releasable attachment mechanisms which may be used in this configuration include a hook and loop attachment mechanism, for example Velcro (RTM), or interlocking brushes. A major requirement for such a releasable attachment mechanism is to inhibit movement of the carpet across the base, as well as to inhibit movement of the carpet away from the base.

Advantageously, the resilient, shock absorbent or cushioning base layer is also configured to allow excess fluid to be drained away from the carpet. Preferably, the base layer is made of a random matrix of fibres, for example Colbond Geosynthetic Enkadrain (RTM). Alternatively, a lattice of rubber material providing shock absorbent characteristics may be configured with channels running therethrough to allow excess fluid to drain away.

Advantageously, the base layer may be attached to the underlying surface using means such as fixing pins. Other fixing means may also be used, for example adhesives or other anchoring mechanisms.

Advantageously, the looped filament carpet has a construction whereby filaments are woven through a backing sheet to provide loops. Preferably the filament is made of polypropylene, which provides a shape memory characteristic and a low friction interface. Other materials may be used, for example nylon, PVC or other plastics. The selection of the material may be used to alter the friction between a user and the surface. For example, the friction between PVC and a user will be greater than between polypropylene and a user. The use of PVC would therefore tend to produce a surface over which the user travels more slowly.

Preferably, the backing sheet is made of an absorbent material which will absorb fluids, in general this will be water from rain, dew or a sprinkler system, although other fluids may be used to provide reduced friction on the surface. When the user compresses the absorbent material, by travelling over the surface, the fluid will be released and the friction between the skis and the carpet will be reduced and the speed at which the user travels over the surface thereby increased. The lower surface of the backing sheet may additionally be provided with a layer of a suitable adhesive compound, for example latex (RTM) or a glue or rubber compound to secure the loops in place whilst still providing a flexible surface.

Advantageously, the carpet may comprise at least two individual tessellating sections, each section comprising a projection along either at least one, and preferably along two adjacent edges, the projection being adapted to be releasably attached to the underside of a tessellating edge of an adjacent section. The carpet base may be contained between an upper and lower layer of water permeable material. The projections may be an extension of the lower layer of material, i.e. a selvedge of the carpet base, or subsequently attached to the lower surface of the carpet base. In this way, the carpet may be provided in sections which are individually laid or removed. This will provide the advantage that when carrying out routine maintenance it will not be necessary to move the entire carpet surface. In addition, for replacement purposes the carpet alone may be removed whilst the base remains in place. A further advantage of fixing the tessellating sections in place is that it will reduce the risk of gaps developing between individual sections which may cause injury to a faller to reduce the efficiency of the surface. Again, the releasable attachment mechanism for attaching the carpet sections to one another may be of a hook and loop form, for example Velcro (RTM), or other suitable attachment means such as releasable adhesives or interlocking brushes.

Advantageously, the carpet may be provided with a plurality of attachment strips on its underside to improve attachment to either the base or a second carpet section.

Advantageously, the loops of the filament carpet may have a random directional weave pattern.

The height of the loops may be constant across the carpet. Alternatively, the loops within the looped filament carpet may have a variety of heights. For example a carpet may be provided with loop heights of 8 mm and 12 mm across its surface. In particular, different loop heights and mixes of loop heights may be used to provide different skiing characteristics, for varying ski levels or uses such as snowboarding or tobogganing. When the loops are arranged to provide a random height pile the resulting artificial ski slope surface will have enhanced edging and brushing characteristics. This is because when the edge of the ski compresses the longer loops the ski will then contact with the shorter loops resulting in greater control for the user.

According to a second aspect of the present invention there is provided a looped filament carpet for use in an artificial ski slope surface, said carpet comprising; a backing sheet having an upper and lower surface; filaments woven through said backing sheet to provide a pile which is continuous across the backing sheet; and releasable attachment means secured to said lower surface.

The pile is unapertured, this is in comparison to configurations provided in the prior art in which spaces are provided between areas of bristles to provide the required frictional characteristics of the surface.

According to a third aspect of the present invention there is provided a method for constructing an artificial ski slope, said method comprising the steps of a) attaching the resilient base layer described above to an underlying surface; and b) releasably attaching a looped filament carpet as described above to said base layer.

Advantageously, the method of attaching the shock absorbent base layer to an underlying surface may be by the use of fixing pins driven through the base layer and into the underlying surface, although, as previously discussed, other fixing mechanisms may also be used.

Advantageously, a plurality of sections of the carpet are attached to the base layer such that each section is releasably attached to one or more adjacent sections. As discussed previously, this reduces the risk of gaps forming between the sections and thereby reduces the risk of injury. Preferably, the plurality of sections tessellate. Advantageously, each section has a projection along at least one edge, most preferably along two adjacent edges, the projection being releasably attached to the underside of an adjacent tessellating section.

### BRIEF DESCRIPTION OF THE DRAWINGS

A number of embodiments of the present invention will now be described by way of example with reference to the accompanying drawings in which:

FIG. 1 shows a side view of a two-part artificial ski slope surface according to the present invention;

FIG. 2 shows an exploded view of the artificial ski slope surface of FIG. 1;

FIG. 3 shows the two parts of the artificial ski slope surface of FIG. 1 being attached or detached;

FIG. 4 shows a plan view of an upper surface of the base layer of an artificial ski slope surface according to the present invention;

FIG. 5 shows a plan view of the underside of a section of a looped filament carpet according to a further embodiment of the present invention;

FIG. 6 shows a plan view of the upper surface of the section as shown in FIG. 5;

FIG. 7 shows a side view of two sections as shown in FIG. 5 when attached to one another;

FIG. 8 shows a plan view of sections as shown in FIG. 5 in a tessellating arrangement; and

FIG. 9 shows the replacement of damaged or worn sections or portions of the looped filament carpet according to the present invention.

### DETAILED DESCRIPTION OF THE DRAWINGS

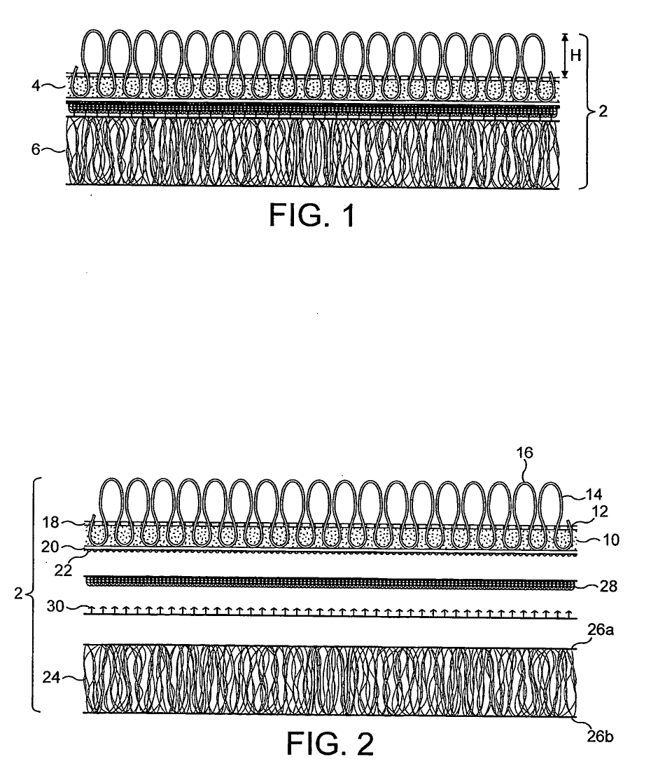

FIGS. 1-3 show an artificial ski slope surface 2, the artificial ski slope surface including a looped filament carpet 4, which may also be described as a blanket, and a base 6. The looped filament carpet 4 and the base 6 are releasably attached to each other.

The looped filament carpet 4 comprises a carpet base 10 having holes 12 therein. A filament 14, preferably made of polypropylene, is woven through the holes 12 to produce a loop 16 extending away from an upper surface 18 of the carpet base 10. Preferably the filament 14 is woven such that no significant loop is apparent extending away from a lower surface 20 of the carpet base 10, such that the loops 16 are locked into position and maintain a fixed height. The loops 16 may provide a uniform directional weave or a random directional weave as desired.

The height H of the loops 16 above the carpet base 10 may be uniform to provide a substantially uniform pile height H and the height H preferably lies in the range from 8 mm to 20 mm. The speed that a skier will travel over the looped filament carpet 4 will tend to increase as the height H of the loops 16 decreases. For example, the speed of the skier over the looped filament carpet 4 when the height of the loops 16 is 8 mm will tend to be faster than when the height of the loops 16 is 20 mm. Since the speed of a user over the looped filament carpet 4 will tend to be reduced as the loop height H increases, looped filament carpets 4 with a larger loop height H may be more suitable for beginners whereas those with a shorter loop height H may be more suitable for more experienced skiers. In skiing terms a looped filament carpet 4 with a shorter loop height H, for example 8 mm, may be used to provide an artificial ski slope with a level of difficulty classed as a “black run”, whereas a looped filament carpet 4 with a larger loop height H loops 16, for example 20 mm, may be used to provide an artificial ski slope with a level of difficulty classed as a green run. It will be understood that the height H of the loop 16 will be selected to provide an optimum speed of travel over the surface and level of difficulty for each individual purpose. For example, if an artificial ski jump is desired for summer training a possible selection will be an 8 mm pile on the slope and a 20 mm pile in the landing area. Thereby providing a fast speed of travel over the slope and a slower speed of travel, facilitating easier stopping, in the landing area.

However, it is also anticipated that an individual looped filament carpet 4 may have loops of two or more different heights to optimise the artificial ski slope surface 2 when desired. An example is a looped filament carpet 4 in which loops of 12 mm and 8 mm are randomly arranged to provide a random height pile.

The holes 12 are spaced so that the pile provided by the loops 14 is continuous. Although the holes may be uniformly spaced it will be apparent that this is not a requirement of the present invention.

The lower surface 20 of the carpet base 10 has a layer 22 of a suitable adhesive compound which aids the securement of the filament 14 to the lower surface 20 and provides a flexible surface which will conform to uneven surfaces.

The carpet base 10 is made of a water absorbent material, for example felt. The material will then absorb water, for example from rain or dew. Additional water will be collected on the loops 16 themselves and in particular on the inside of the loop. The combination of the water absorbed by the carpet base 10 and the water collected on the loops 16 will enhance any low friction characteristic of the artificial ski slope surface 2 leading to a reduced requirement for watering by a sprinkler system.

The base 6 is typically formed of randomly formed fibres 24, for example made of nylon. The fibres 24 may be contained between an upper and a lower sheet of material 26a and 26b, with at least the upper sheet 26a being made of a water permeable material. The fibres 24 are configured to form a random matrix. The matrix is designed to be capable of elastic deformation and to therefore provide at least some degree of shock absorption. The base 6 is configured to allow excess water to drain away from the carpet 4. The water may then run down a slope through the base 6 or into a drainage system, not shown, which is often provided on artificial ski slopes, or directly into the ground.

The base 6 is designed to be flexible and may be secured to the ground, or any other slope surface, using suitable fixing pins to ensure location.

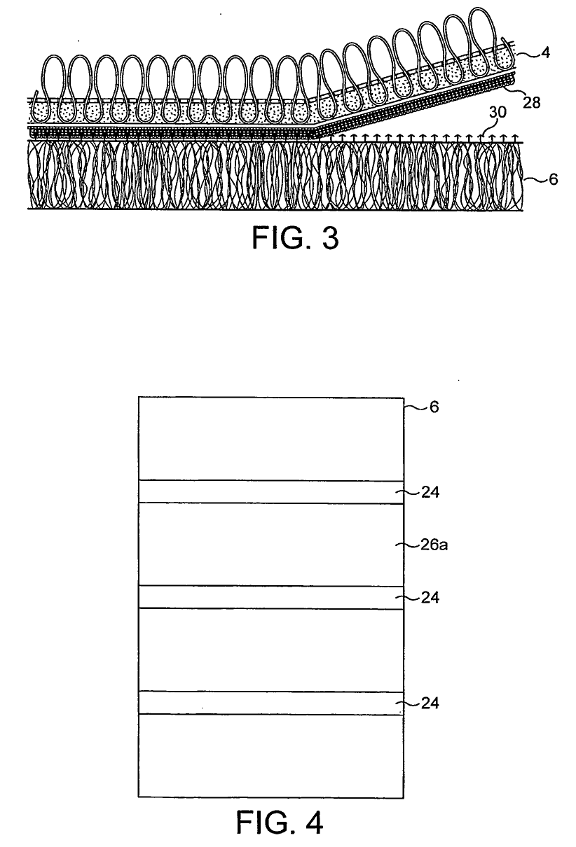

FIG. 3 shows how the looped filament carpet 4 and the base 6 are releasably attached to one and other. In the present embodiment the lower surface 20 of the looped filament carpet 4 has a loop part 28 of a hook and loop attachment mechanism attached thereto and the upper surface 26a of the base 6 has a complementary hook part 30 of the hook and loop attachment mechanism attached thereto. When the looped filament carpet 4 is laid on to the base 6 the loop and hook parts, 28 and 30 respectively, interlink to restrict movement between the looped filament carpet 4 and the base 6. The hook and loop attachment mechanism may be provided over the whole interface or at corresponding points on the lower surface 20 and the upper surface 26a.

FIGS. 4-9 show an alternative embodiment wherein the carpet 4 is provided in easy to manage interlinking sections 32.

FIG. 4 shows a plan view of a section of the base 6 which has strips 34 of material forming one part of a hook and loop attachment mechanism which are attached to the upper surface 26a of the base 6.

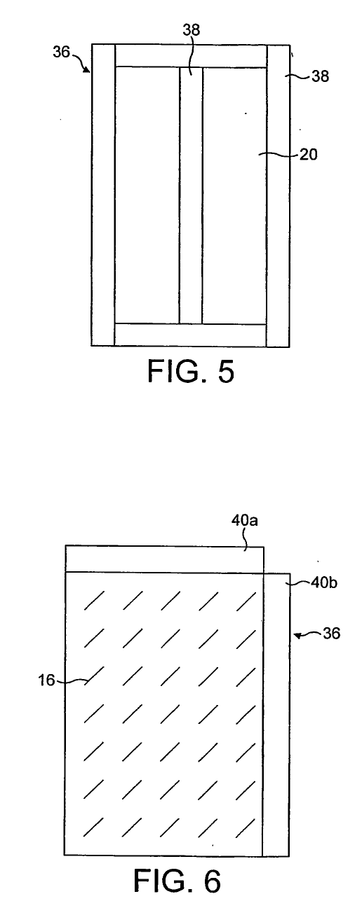

FIG. 5 shows the underside of a section 36, shown in the same configuration as the base 6 of FIG. 4. Strips 38 providing the other part of the hook and loop attachment mechanism are attached to the lower surface 20 of section 36. In the configuration shown, strips 38 extend around the perimeter of section 36 and an additional strip is provided in a direction perpendicular to the strips 34 provided on the base 6. Such an orientation provides point contacts between strips 34 and 38 and means that accuracy in laying is not as important as if the strips needed to be correctly aligned ie. if the strips 34 and 38 had the same orientation. However, as previously discussed it is understood that the use of corresponding strips or points on the lower surface 20 and upper surface 26a is possible.

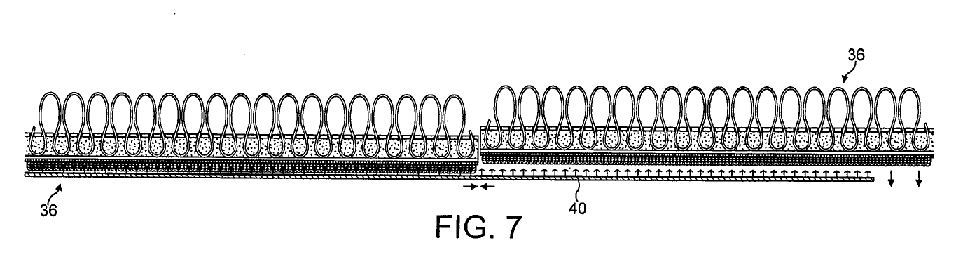

Looking at FIGS. 6 and 7 there is shown a plan view and a side view of the looped filament carpet 4. In the present embodiment there are two projections 40a and 40b which extend outwardly from the lower surface 20 the carpet base 10. The projections 40a and 40b do not form part of the looped filament carpet 4 and have no loops 16 woven through them. The projections 40a and 40b are provided with one part of a hook and loop attachment mechanism which will attach to the part of the hook and loop system provided on the strips 34 on an adjacent section 36.

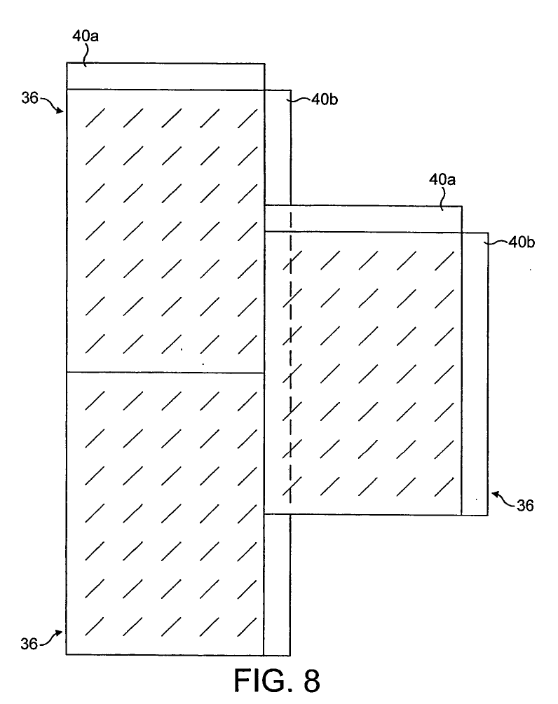

As shown in FIG. 8 the sections 36 are laid such that each section 36 tessellates with the adjacent section and is secured in place by the attachment mechanism.

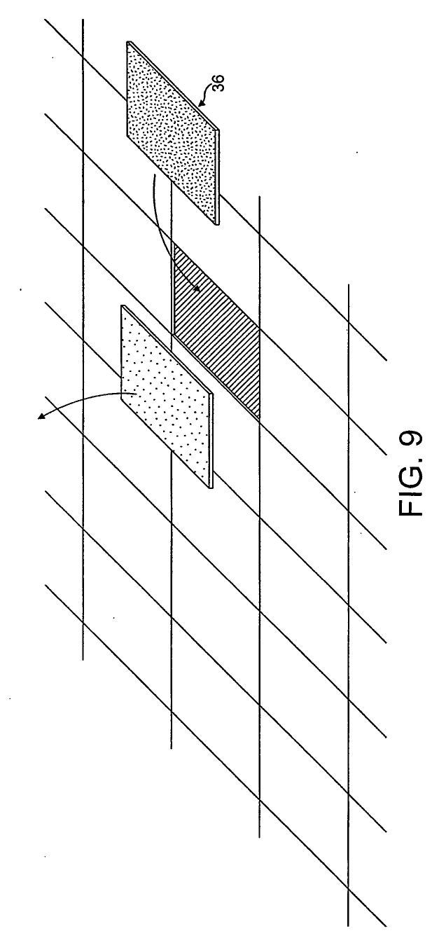

One advantage of providing interlinking sections is that worn or damaged sections may be easily replaced without the need to cut away parts of the carpet 4 or replace the whole carpet 4 and this is illustrated in FIG. 9. A further advantage is that a temporary ski slope, for example at shows or exhibitions, may be readily assembled and disassembled.

If a smaller portion of the looped filament carpet requires replacing it is possible to cut away the worn/damaged portion and provide a replacement portion of the looped filament carpet. The replacement portion may have one part of an attachment mechanism attached to the lower surface, the other part of the attachment mechanism being attached to the exposed portion of the base, so that when the replacement portion is placed in position it is releasably secured to the base.

A further advantage of the system of the present invention is that the base 6 may remain in situ when sections 36 are replaced during routine maintenance.

In order to lay a complete artificial ski slope according to the present invention the base 6 is laid and secured to a surface, for example the ground or a suitable artificial surface. Once the base 6 is correctly in position the looped filament carpet 4 is attached to the base 6 to form a continuous pile on the usable surface.

According to a specific embodiment of the present invention an artificial ski slope surface may be manufactured using a Colbond Geosynthetic Enkadrain (RTM) to provide a base to satisfy the requirements for drainage and cushioning. A Velcro (RTM) product is used to secure the base to a lower surface of a looped filament carpet. The looped filament carpet comprises a polyester PBT transparent monofilament which is dia-stitched through a felt material. The monofilament is 2.3 mm wide by 0.55 mm thick. The felt material is sandwiched between an upper and lower layer of a polypropylene cloth and the lower surface of the felt material is coated with a latex layer.

When in use, a user glides over the surface, for example on skis, as the loops 14 deform sufficiently to allow edging of the skis, thereby enabling the skier to turn or stop. It has also been found that the carpet 4 of the present invention will retain a visible track when a user has passed over the surface as is seen on snow, which is useful for training purposes.

Although the invention has been described as being suitable for skiing it will also be appreciated that the surface may be used for other sports where gliding over a surface is a requirement, for example snowboarding, tobogganing or other winter sports.

1. An artificial ski slope for laying on an underlying surface, said artificial surface comprising;
a looped filament carpet; and
a resilient base layer, and said carpet being releasably attached to said base layer.

2. An artificial ski slope surface as claimed in claim 1, wherein said base layer is adapted to provide drainage of excess fluid from said carpet.

3. An artificial ski slope surface as claimed in claim 1, wherein said base layer is attached to the underlying surface using fixing pins.

4. An artificial ski slope surface as claimed in claim 1, wherein said looped filament carpet has a construction whereby filaments are woven through a backing sheet to provide loops.

5. An artificial ski slope surface as claimed in claim 4, wherein said filaments are made of at least one of polypropylene, PVC or nylon.

6. An artificial ski slope surface as claimed in claim 4, wherein said backing sheet is made of an absorbent material.

7. An artificial ski slope surface as claimed in claim 1, wherein said carpet is releasably attached to said base layer using a loop and hook arrangement.

8. An artificial ski slope surface as claimed in claim 1, wherein said carpet comprises at least two individual tessellating sections, each section comprising a projection along at least one edge, said projection being adapted to be releasably attached to the underside of a tessellating section.

9. An artificial ski slope surface as claimed in claim 1, wherein said carpet is provide with a plurality of attachment strips secured to the underside of said carpet.

10. An artificial ski slope surface as claimed in claim 1, wherein the loops have a random directional weave pattern.

11. An artificial ski slope surface as claimed in claim 1, wherein the looped filaments have at least two different heights.

12. An artificial ski slope surface as claimed in claim 11, wherein the difference in height between shortest and longest loops is at least 15% of the height of the shortest loops.

13. A looped filament carpet for use in an artificial ski slope surface, said carpet comprising:
a backing sheet having an upper and lower surface;
filaments woven through said backing sheet to provide a pile which is continuous across the backing sheet; and
releasable attachment means secured to said lower surface.

14. A looped filament carpet as claimed in claim 13, wherein the filaments are made of at least one of polypropylene, PVC or nylon.

15. A looped filament carpet as claimed in claim 13, wherein said backing sheet is made of an absorbent material.

16. A looped filament carpet as claimed in claim 13, wherein said releasable attachment means is a loop and hook arrangement.

17. A looped filament carpet as claimed in claim 13, wherein said carpet comprises at least two individual tessellating sections, each section comprising a projection along at least one edge, said projection being adapted to be releasably attached to the underside of a tessellating section.

18. A looped filament carpet as claimed in claim 13, wherein said carpet is provided with a plurality of attachment strips secured to the underside of said carpet.

19. A looped filament carpet as claimed in claim 13, wherein the loops have a random directional weave pattern.

20. A looped filament carpet as claimed in claim 13, wherein the looped filaments have at least two different hieghts.

21. A looped filament carpet as claimed in claim 13, wherein the difference in height between the shortest and longest loops is at least 15% of the height of the shortest loops.

22. A method of constructing an artificial ski slope, said hod comprising the steps of:
(a) attaching a shock absorbent base layer to an underlying surface; and
(b) releasably attaching a looped filament carpet to said base layer.

23. A method of constructing an artificial ski slope as claimed in claim 22, wherein the step of releasably attaching uses a hook and loop mechanism.

24. The method of claim 23, wherein said step of releasably attaching said carpet to said base layer further includes:
separately attaching a plurality of sections of said carpet to said base layer such that each section is also releasably attached to one or more adjacent sections.

25. The method of claim 24, wherein:
said plurality of sections tessellate.

26. The method of claim 25, wherein:
said plurality of sections are provided with a projection along at least one edge; and
said projection is releasably attached to the underside of a tessellating section.

27-35. (canceled)
